(19) United States
(12) Patent Application Publication
(10) Pub. No.: US 2014/0346378 A1
(43) Pub. Date: Nov. 27, 2014

(54) MICROFLUIDIC VALVE MODULE AND SYSTEM FOR IMPLEMENTATION

(71) Applicants: Chin Hock Kua, Singapore (SG); Zhenfeng Wang, Singapore (SG); Wei Fan, Singapore (SG); Cong Zhi Leon Chan, Singapore (SG); Zhiping Wang, Singapore (SG)

(72) Inventors: Chin Hock Kua, Singapore (SG); Zhenfeng Wang, Singapore (SG); Wei Fan, Singapore (SG); Cong Zhi Leon Chan, Singapore (SG); Zhiping Wang, Singapore (SG)

(73) Assignee: AGENCY FOR SCIENCE, TECHNOLOGY AND RESEARCH, Singapore (SG)

(21) Appl. No.: 13/977,480

(22) PCT Filed: Dec. 21, 2011
(86) PCT No.: PCT/SG11/00447

§ 371 Date: Jan. 9, 2014

(30) Foreign Application Priority Data
Dec. 30, 2010 (SG) 201009741

(51) Int. Cl. F16K 99/00

(52) U.S. Cl. CPC F16K 99/0015; F16K 99/0061
USPC 251/61.1; 251/331

(57) ABSTRACT

An improved microfluidic system with an improved microfluidic valve module is disclosed. The microfluidic system includes a microfluidic chip and one or more valve modules. The microfluidic chip has microfluidic channels and one or more cavities formed in the chip, each of the one or more cavities designed to receive one of the one or more valve modules. Each of the one or more valve modules includes a first layer, a control layer and one or more second layers. The first layer includes a deformable material. The control layer has a microfluidic control chamber formed in a portion of it. The control layer is also located adjoining the first layer and the deformable material of the first layer forms a deformable surface of the control chamber. The one or more second layers include an input microfluidic channel and an output microfluidic channel. The input microfluidic channel and the output microfluidic channel are fluidically coupled to the microfluidic control chamber, and fluid flow through the input microfluidic channel, the microfluidic control chamber and the output microfluidic channel is controlled in response to a force deforming the deformable material of the first layer at least a predetermined amount.

### CROSS-REFERENCE TO RELATED APPLICATION

The present application claims priority to Singapore Patent Application No. 201009741-8, filed Dec. 30, 2010.

### FIELD OF THE INVENTION

The present invention generally relates to fluidic valves, and more particularly relates to modules for microfluidic valves and systems implementing such valve modules.

### BACKGROUND OF THE DISCLOSURE

Microfluidic systems are typically on-chip devices for handling small samples of fluid for testing purposes, such as forensic testing, environmental testing, blood testing, genomic testing or other biological or chemical testing.

Prior art devices have blade-type actuators which can constrict the flow in a tube, thereby controlling the flow of fluid in the microfluidic system. In this manner, some prior art systems were able to provide controlled flow to multiple locations or channels on a single microfluidic chip. However, such flow was dependent upon the constriction that could be provided to the channel. Failure to fully stop the fluid flow could result in contaminated test results. Valve modules could also be provided, but the construction of systems using such valves is typically expensive and provides only a single-use test system because such microfluidic systems are difficult (if not impossible) to completely clean and/or remove any contaminants for a reuse.

Thus, what is needed is a low cost microfluidic valve module design. Furthermore, other desirable features and characteristics will become apparent from the subsequent detailed description and the appended claims, taken in conjunction with the accompanying drawings and this background of the disclosure.

### SUMMARY

According to the Detailed Description, a microfluidic system is provided. The microfluidic system includes a microfluidic chip and one or more valve modules. The microfluidic chip has microfluidic channels and one or more cavities formed in the chip, each of the one or more cavities designed to receive one of the one or more valve modules. Each of the one or more valve modules includes a first layer, a control layer and one or more second layers. The first layer includes a deformable material. The control layer has a microfluidic control chamber formed in a portion of it. The control layer also adjoins the first layer and the deformable material of the first layer forms a deformable surface of the control chamber. The one or more second layers include an input microfluidic channel and an output microfluidic channel. The input microfluidic channel and the output microfluidic channel are fluidically coupled to the microfluidic control chamber, and fluid flow through the input microfluidic channel, the microfluidic control chamber and the output microfluidic channel is controlled in response to a force deforming the deformable material of the first layer at least a predetermined amount.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with the present invention.

FIG. 1 illustrates a diagram of a microfluidic system in accordance with a present embodiment.

FIG. 2, including FIGS. 2A and 2B, illustrates an exemplary microfluidic valve module in accordance with the present embodiment, wherein FIG. 2A illustrates the valve module in an OPEN orientation and FIG. 2B illustrates the valve module in a CLOSED orientation.

FIG. 3 is a cutaway top, left, front perspective view of the valve module of FIG. 2 in accordance with the present embodiment.

FIG. 4, including FIGS. 4A, 4B, 4C and 4D, pictorially illustrates a method for making the microfluidic system of FIG. 1 in accordance with the present embodiment.

FIG. 5 is a top planar view of the microfluidic system of FIG. 1 in accordance with the present embodiment under a first test condition.

FIG. 6 is a top planar view of the microfluidic system of FIG. 1 in accordance with the present embodiment under a second test condition.

Skilled artisans will appreciate that elements in the figures are illustrated for simplicity and clarity and have not necessarily been drawn to scale. For example, the dimensions of some of the elements in the figures illustrating integrated circuit architecture may be exaggerated relative to other elements to help to improve understanding of the present and alternate embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

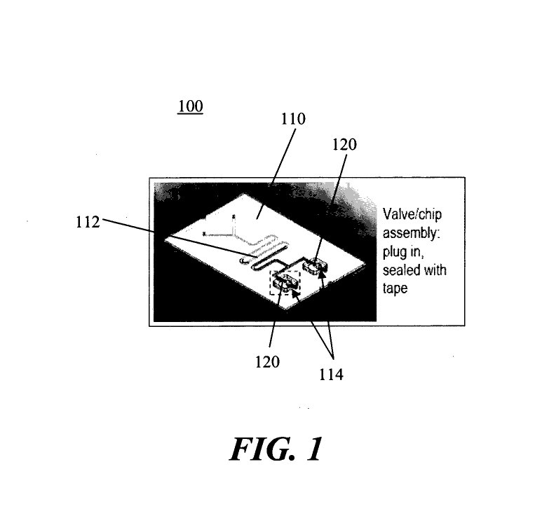

Referring to FIG. 1, a microfluidic system 100 in accordance with an embodiment is depicted. The microfluidic system 100 includes a microfluidic chip 110 and valve modules 120. The microfluidic chip 110 may be composed of a rigid material, preferably transparent, such as polymethyl methacrylate (PMMA) and has microfluidic channels 112 and cavities 114 formed therein. Each of the cavities 114 is designed to snugly receive one of the valve modules 120. In this manner multipoint valving can be used to provide multiple tests on a single microfluidic chip 110 by providing multiple valve modules 120.

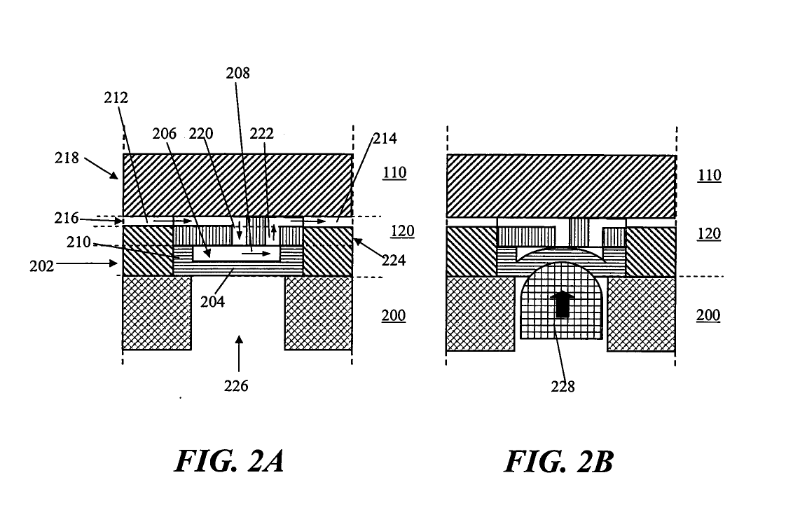

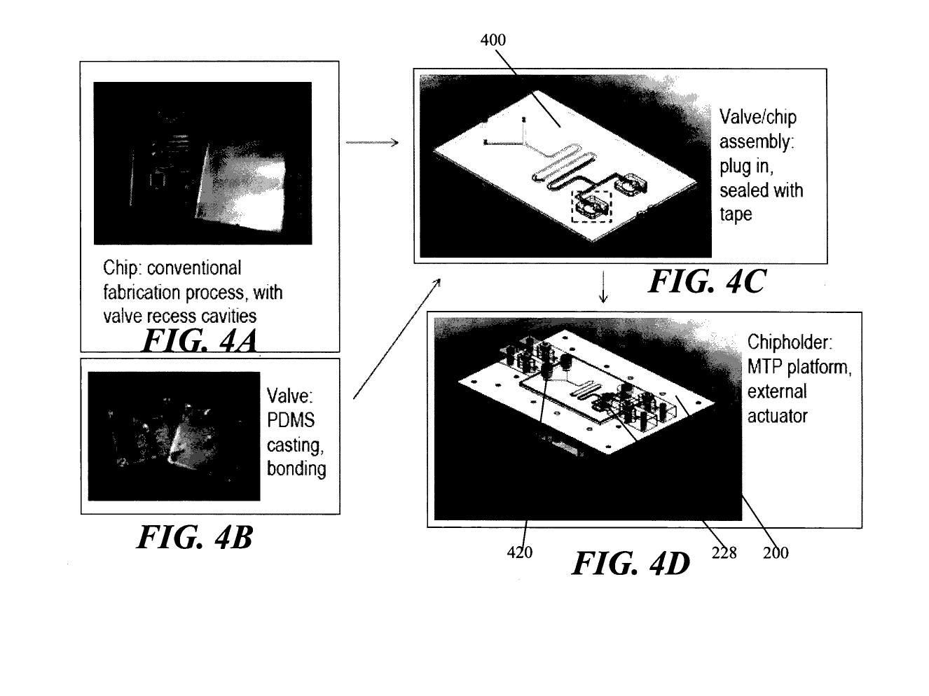

The microfluidic valve module 120 in accordance with the present embodiment is shown in FIGS. 2A and 2B. The microfluidic valve module 120 is depicted in FIGS. 2A and 2B within a cavity of the microfluidic chip 110, the whole apparatus mounted on a test platform 200 (discussed in more detail in association with FIG. 4D hereinbelow). FIG. 2A shows the valve module 120 in an OPEN orientation and FIG. 2B shows the valve module 120 in a CLOSED orientation. A first layer 202 includes a deformable material 204 such as Polydimethylsiloxane (PDMS). The deformable material 204 forms one surface 206 of a microfluidic control chamber 208. The microfluidic control chamber 208 is formed in a portion of a control layer 210, the control layer 210 adjoining just above the first layer 202. The microfluidic control chamber 208 could be formed as a channel wherein the deformable surface 206 is rectangular. Alternatively, the microfluidic control chamber 208 could be formed as a circular or square chamber wherein the deformable surface 206 is circular or square, respectively. The shape and surface area of the deformable surface 206 can be designed to provide ease of deforming of the surface 206 within the constraints of the specifications of the valve module 120.

An input microfluidic channel 212 and an output microfluidic channel 214 are formed in another layer 216 above the control layer 210. A top layer 218 forms an upper surface of the input microfluidic channel 212 and the output microfluidic channel 214. While shown in FIGS. 2A and 2B as being formed in the same layer 216, the input microfluidic channel 212 and the output microfluidic channel 214 could alternatively be formed in different layers such as one formed in the layer 216 and the other formed in the top layer 218.

The input microfluidic channel 212 and the output microfluidic channel 214 are fluidically coupled to the microfluidic control chamber 208 via vertical channels 220, 222 formed in an intermediate layer 224. Those skilled in the art will recognize that intermediate layer 224 could be a single layer or multiple layers depending upon the fabrication method used. The vertical channel 220 provides a fluid inlet to the control chamber 208 and vertical channel 222 provides a fluid outlet from the control chamber 208.

When the valve module 120 is situated in the cavity 114 of the microfluidic chip 110, the deformable material 204 is located above a channel 226 formed in the test platform 200. The channel 226 is designed to allow a force, such as a mechanical or fluidic force, to access the valve module 120 in order to deform the deformable material 204. For example, a mechanical force could be provided by a solenoid activated actuator 228 (FIG. 2B) which accesses the valve module 120 through the channel 226 in order to deform the deformable material 204. Alternatively, a fluidic force of air pressure could be provided by pneumatically providing compressed air through the channel 226 to deform the deformable material 204. As those skilled in the art will realize, pneumatic control can be provided much cheaper than mechanical actuator control of the microfluidic valve modules 120.

Deforming the deformable material 204 (as shown in FIG. 2B) at least a predetermined amount will stop fluid flow from the vertical channel 220 into the control chamber 208. In this manner, fluid flow through the control chamber 208 is controlled by the force applied in that the deforming of the deformable material 204 to bring the deformable surface 206 to cover the vertical channel 220 constricts the fluid flow from the input microfluidic channel 212 to the microfluidic control chamber 208.

Referring to FIG. 2B, the actuator 228 is shown deforming the deformable material 204. As discussed above, compressed air can alternatively be provided through a pneumatic system to provide the force for deforming the deformable material 204. As seen in FIG. 2B, the actuator 228 has deformed the deformable material 204 at least a predetermined amount sufficient to block the vertical channel 220 inletting fluid into the microfluidic control chamber 208. The predetermined amount is a distance corresponding to a thickness of the microfluidic control chamber 208, where the length of the microfluidic control chamber is measured along the deformable surface 206 and the thickness is measured perpendicular to a plane of the deformable surface 206. A surface area of the microfluidic control chamber 208 is sufficient to allow deforming the deformable material 204 along the deformable surface 206 by the actuator 228 (or other force) for at least the thickness of the microfluidic control chamber 208. Deforming the deformable surface 206 by the force applied for more than the thickness of the microfluidic control chamber 208 will also block fluid flow in the vertical channel 220, thereby constricting the fluid flow from the input microfluidic channel 212 to the microfluidic control chamber 208. The primary criteria for control of flow through the valve module is deforming the deformable material 204 in a manner to cover the vertical channel 220 (i.e., the inlet channel), thereby blocking fluid flow from the input microfluidic channel 212 to the microfluidic control chamber 208.

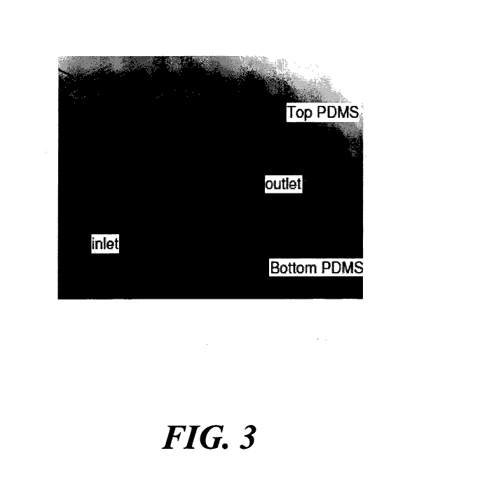

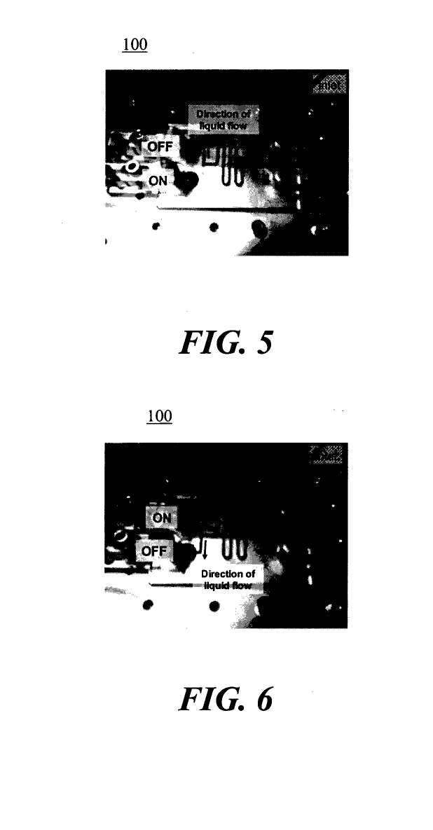

Referring to FIG. 3, a cutaway top, left, front perspective view of the valve module 120. The vertical channel 220 provides an inlet to the microfluidic control chamber 208, and the vertical channel 222 provides an outlet to the microfluidic control chamber 208. The control chamber 208 depicted in FIG. 3 is a circular shaped chamber. Because of the flow through the vertical channels 220, 222, the valve module 120 will work better in the orientation where the microfluidic control chamber 208 is below the input microfluidic channel 212 and the output microfluidic channel 214. As will be seen later in FIGS. 5 and 6, this allows less fluid to be maintained in a microfluidic channel leading to a CLOSED valve module 120. The circular shaped control chamber 208 also provides better deformation in response to less force, therefore providing better operation of the valve module 120 when the force is provided by a pneumatic system.

FIG. 4 pictorially depicts a method for manufacturing the microfluidic system 100 in accordance with the present embodiment. FIG. 4A represents fabrication of the microfluidic chip 110, including the microfluidic channels 112 and the cavities 114. The microfluidic chip is fabricated using conventional techniques, and including the cavities 114 for later adding the valve modules 120. The microfluidic chip 110, including the two portions showing could be fabricated using a rigid material such as PMMA as discussed above. Alternatively, the microfluidic chip 110 and the valve module(s) 120 could be fabricated of the same deformable material for ease and cost reduction of the fabrication process. FIG. 4B represents fabrication of the valve modules 120 as described hereinabove. A polymeric organosilicon compound such as Polydimethylsiloxane (PDMS) material can be used to fabricate the valve modules. This material can be cast and bonded to create the modular structure shown in FIG. 2. Alternatively, the valve modules can be fabricated using more than one material, such as a combination of PMMA and PDMS parts. Fabricating the microfluidic chip 110 and the microfluidic valve modules 120 separately, as shown in FIGS. 4A and 4B, allows ease of fabrication without any special processes for fabricating the chip 110 and the valve modules 120 together.

FIG. 4C represents the combination of the microfluidic chip 110 from FIG. 4A with the valve modules 120 from FIG. 4B to create a valve/chip assembly 400 by plugging one of the valve modules 120 into each of the cavities 114 which, as discussed before, have been fabricated designed to snugly receive a valve module 120. The valve modules 120 are then bonded to each cavity 114 to assure that the valve modules 120 remain in the cavities 114. Use of PDMS in the fabrication of both the valve modules 120 and the microfluidic chip 110 would provide the additional advantage of improved ease of bonding the valve modules 120 to the microfluidic chip 110 as bonding same materials is easier than bonding different materials. The material and fabrication of the microfluidic chip 110 and the valve module(s) 120 in accordance with the present embodiment allow sufficient cost savings and opportunities for additional cost reduction such that the microfluidic system 100, including the microfluidic chip 110 and the valve modules 120, provide a cost efficient, disposable single-use microfluidic system 100. FIG. 4D represents the final construct of the microfluidic system. A test platform 200 includes the valve/chip assembly 400 along with external actuators 228 and inlet tubes 420 to provide fluid to the microfluidic system 100. As discussed before, the actuators 228 and accompanying solenoids could be replaced with a less expensive pneumatic air pressure system for providing compressed air to activate the valve modules 120. The material and fabrication of the microfluidic chip 110 and the valve module(s) 120 in accordance with the present embodiment allow sufficient cost savings and opportunities for additional cost reduction such that the microfluidic system 100, including the microfluidic chip 110 and the valve modules 120, provide a cost efficient, disposable single-use microfluidic system 100.

Referring to FIG. 5, a top planar view of the microfluidic system 100 is depicted on a test platform 200 under a first test condition using actuators 228 to provide the force for deforming the deformable material 208. The lower actuator is ON (thereby CLOSING the lower valve module 120). The upper actuator is OFF allowing the upper valve module 120 to remain OPEN. It can be seen that the colored fluid flows from the inlet tube to the OPEN valve module 120 (i.e., the upper valve module 120). FIG. 6 is a top planar view of the microfluidic system 100 depicting it under a second test condition. The lower actuator is OFF (thereby OPENING the lower valve module 120). The upper actuator is turned ON closing the upper valve module 120. It can be seen in FIG. 6 that the colored fluid now flows from the inlet tube to the OPEN valve module 120 (i.e., the lower valve module 120).

Thus it can be seen that a microfluidic system 100 and a low cost, disposable microfluidic valve module 120 for such system 100 has been provided. Such microfluidic system 100 in accordance with the present embodiment can provide microfluidic flow rates up to 10 ml/min. In addition, the microfluidic system 100 in accordance with the present embodiment has been observed to be able to withstand up to a maximum air pressure of approximately 20 kPa. While several exemplary embodiments have been presented in the foregoing detailed description of the invention, it should be appreciated that a vast number of variations exist, including variations as to the materials used to form the various layers of the valve module 120 and the microfluidic chip 110.

It should further be appreciated that the exemplary embodiments are only examples, and are not intended to limit the scope, applicability, dimensions, or configuration of the invention in any way. Rather, the foregoing detailed description will provide those skilled in the art with a convenient road map for implementing an exemplary embodiment of the invention, it being understood that various changes may be made in the function and arrangement of elements and method of fabrication described in an exemplary embodiment without departing from the scope of the invention as set forth in the appended claims.

What is claimed is:

1. A microfluidic system comprising:
a microfluidic chip having microfluidic channels formed therein; and
one or more valve modules,
wherein the microfluidic chip has one or more cavities formed therein, each of the one or more cavities designed to receive one of the one or more valve modules, and wherein each of the one or more valve modules comprises:
a first layer comprising a deformable material;
a control layer adjoining the first layer and having a microfluidic control chamber formed in a portion thereof, the deformable material forming a deformable surface of the control chamber; and
one or more second layers having an input microfluidic channel and an output microfluidic channel formed therein, the input microfluidic channel and the output microfluidic channel fluidically coupled to the microfluidic control chamber, wherein fluid flow through the input microfluidic channel, the microfluidic control chamber and the output microfluidic channel is controlled in response to a force deforming the deformable material of the first layer at least a predetermined amount.

2. The microfluidic system in accordance with claim 1 wherein deforming the deformable material at least the predetermined amount controls fluid flow by constricting fluid flow from the input microfluidic channel to the microfluidic control chamber.

3. The microfluidic system in accordance with claim 2 wherein each of the one or more valve modules further comprises one or more intermediate layers, wherein each of the one or more intermediate layers has at least a portion of a plurality of vertical channels formed therein, and wherein a first one of the plurality of vertical channels fluidically connects the input microfluidic channel to the microfluidic control chamber, and wherein a second one of the plurality of vertical channels fluidically connects the microfluidic control chamber to the output microfluidic channel.

4. The microfluidic system in accordance with claim 3 wherein deforming the deforming material at least the predetermined amount stops fluid flow from the first one of the plurality of vertical channels into the microfluidic control chamber.

5. The microfluidic system in accordance with claim 1 wherein the microfluidic control chamber has a length and a thickness associated therewith, and wherein the length of the microfluidic control chamber is along the deformable surface while the thickness is perpendicular to a plane of the deformable surface, and wherein the length of the microfluidic control chamber is sufficient to allow deforming the deformable surface by the actuator for the thickness of the microfluidic control chamber.

6. The microfluidic system in accordance with claim 1 wherein the one or more second layers further comprise a layer forming an upper surface of one or more of the input microfluidic channel and the output microfluidic channel.

7. The microfluidic system in accordance with claim 1 wherein the force deforming the deformable material of the first layer at least the predetermined amount is a motive force selected from the group comprising a mechanical force and a fluidic force.

8. The microfluidic system in accordance with claim 7 further comprising one or more actuators, each of the one or more actuators associated with one of the one or more valve modules for providing a mechanical force for deforming the deformable surface of the control chamber at least the predetermined amount to control fluid flow through the control chamber.

9. The microfluidic system in accordance with claim 7 further comprising one or more pneumatic chambers, each of the one or more pneumatic chambers associated with one of the one or more valve modules for providing a pneumatic compressed air fluidic force for deforming the deformable surface of the control chamber at least the predetermined amount to control fluid flow through the control chamber.

10. The microfluidic system in accordance with claim 1 wherein the deformable surface of the control chamber has a shape selected from the group of shapes comprising circular, rectangular and square.
